(19) United States
(12) Patent Application Publication
(10) Pub. No.: US 2004/0154394 A1
(43) Pub. Date: Aug. 12, 2004

(54) Tachometer device having rotation speed indicative projection light source

(76) Inventor: Jui-Yang Lo, Junghe-City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/771,442

(22) Filed: Feb. 5, 2004

Related U.S. Application Data
(63) Continuation-in-part of application No. 10/086,732, filed on Mar. 4, 2002, now abandoned.

(51) Int. Cl. G01P 15/00

(52) U.S. Cl. 73/491

(57) ABSTRACT

A tachometer with a projection light source generating light of a color corresponding to an instant rotational speed of the car engine to indicate to a racer the best time for gear shift switching by changing the color of the generated light. The device includes a micro-processor, a memory device where a color corresponding to a respective speed segment, as well as speed value critical for shift switch are recorded, and a light source device including a switch device, an electric-control loop and a RGB illumination device set. The light source device is controlled by the microprocessor to change the color of the generated light when the speed reaches the critical value pre-set by a user.

### CROSS REFERENCE OF RELATED APPLICATION

The present invention is a Continuation-in-part (CIP) application of a pending-non-provisional patent application with application Ser. No. 10/086,732 filed on Mar. 4, 2002.

### BACKGROUND OF THE INVENTION

1. Field of the Invention

This invention relates to a tachometer used in a car, and more particularly, to a tachometer device with a projection light source changing the color of the generated light according to the rotational speed of the car engine, wherein the projection light source changes the color of the light when the rotational speed of the car engine reaches a predetermined value.

2. Description of the Prior Art

In the auto racing, the shifting at suitable engine rotational speeds is an important factor for gaining maximum power as well as attaining sufficient racing speed. To determine the right moment to shift gear speeds, a racer has to read an instant engine rotational speed, which is quite a challenge while driving at high speed.

It would be highly desirable to provide racing cars with sufficient means to aid a driver to quickly and effortlessly ascertain the level of engine rotational speed.

### SUMMARY OF THE INVENTION

It is therefore a purpose of this invention to provide a tachometer device for a car with a projection light source including an RGB illumination device set equipped in the inner portion of the tachometer device which switches between different colors of the generated light (such as red, green, blue, yellow, indigo-blue, purple, white)according to the rotational speed of the car engine (such as, for example, 1000 RPM or 500 RPM), so that the color of the generated light indicates to the car driver an instant rotational speed condition of the car engine, thus sufficiently simplifying the rotational speed reading procedure.

Another purpose of this invention is to provide a tachometer device with a projection light source including an RGB illumination device set equipped in the inner portion of the tachometer device beneath the graduation board so as to generate a particular color of the light corresponding to preset rotational speed of the car engine indicated on the graduation board of the tachometer thereby reminding the driver of with what speed the car is advancing now.

Another purpose of this invention is to provide a tachometer device with a the projection light source, which has a presetting mode, when a user records in the memory of the tachometer device for a particular color of the light source corresponding rotational speed. The device memorizes the respective values of the speed corresponding to respective colors so that when the tachometer device is being reset or being re-initiated, said corresponding color-speed correspondence need not be reset again.

According to the present invention, a tachometer device includes a microprocessor and a memory, and is provided with a projection light source which includes:

a switch device,

an electric-control loop, which receives a control signal from the microprocessor indicative of what color the light source has to generate. It also is used to receive the switch signal from the switch device when the speed has reached a predetermined critical value indicative of switching the color of the generated light; and

an RGB illumination device set equipped in the inner portion of the tachometer device beneath the graduation board receives a driving signal from the electric-control loop to generate light of a color corresponding to an instant rotational speed of the car engine.

These features and advantages of the present invention will be fully understood and appreciated from the following detailed description of the accompanying Drawings.

### BRIEF DESCRIPTION OF THE DRAWINGS

FIG. 1 is a circuit block diagram of the tachometer device of the present invention; and

FIG. 2 is a perspective view of the tachometer device of the present invention.

### DETAILED DESCRIPTION OF THE PREFERRED EMBODIMENT

A tachometer device of the present invention allows the user to set-up a critical rotational speed value of a car engine to determine an optimum shift-switch time. In addition, the tachometer device records the condition of the highest rotational speed during car racing. The device of the present invention comprises; a meter body which covers all the components of the tachometer device; a microprocessor which is used to process input signals and to control the operation of the tachometer device; a functional selection operation device which is used by a user to set up correspondence between the speed values and colors of generated light, which are recorded in a memory device (through the functional selection operation device the user also can set up critical speed values at which gear shift is to be switched); and a cylinder changeover switch which could be used to select the cylinder type.

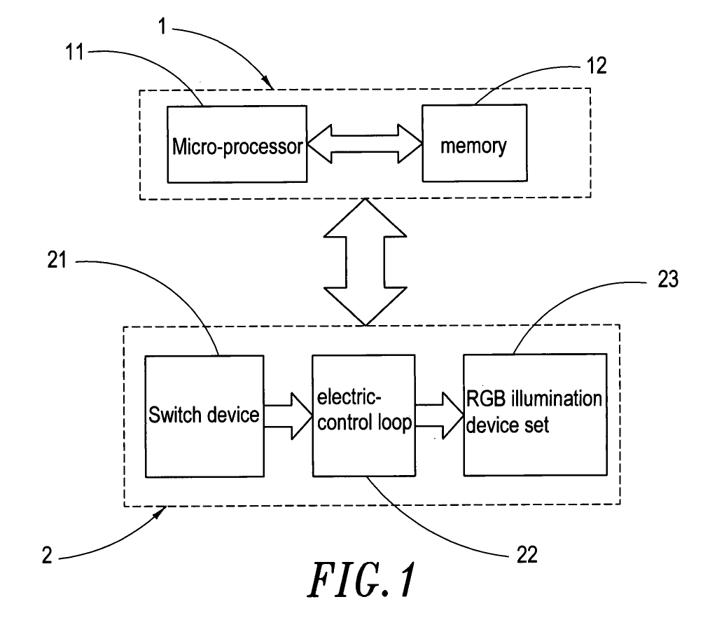

Referring to FIG. 1, a light source device 2 is coupled to the original tachometer circuit 1, wherein the light source device 2 comprises:

a switch device 21, which is used to output a switch signal (or a set-up signal) onto an electric-control loop 22 once a critical speed value is reached indicative of necessity to change the color of the generated light (the change of the color indicates to the car driver an optimal time for gear shift switching);

the electric-control loop 22, which is used to receive the control signal from the micro-processor 11, and which is also used to receive the switch signal (or the set-up signal) from the switch device 21. The electric-control loop 22 processes the control signal from the micro-processor 11 which “indicates” to the electric-control loop 22 what color the instant rotational engine speed corresponds to. Also, the loop 22 is controlled by the switch device 21 to switch the color once a respective critical rotational speed value has been reached. Thus, in response to both the switch signal output from the switch device 21, and to control signal from the microprocessor 11, the electric-control loop 12 outputs the signal to the RGB illumination device set 23.

The RGB illumination device set 23, is positioned inside the meter body namely, appropriately positioned beneath the graduation board. It receives the driving signal from the electric-control loop 22 prompting the RGB illumination device 23 to change the color of the generated light to a color corresponding to an instant engine rotational speed, wherein R=red; G=green; B=blue; R+G=yellow; G+B=indigo-blue; R+B=purple; R+G+B=white.

The electric-control loop 22 drives the RGB illumination device set 23 by means of synchronized light-mixing technique when a specific speed segment is recorded in the memory 12 in correspondence with a respective color. The rotating tachometer has a plurality of speed segments, and therefore can display light of various colors. The device can switch the color light source between the colors such as red, green, blue, yellow, indigo-blue, purple, white by means of the switch device 21. Under the control of the microprocessor 11 program, the color of the light generated by the light source 2 can be set up according to the rotating speed segment (such as, for example, one segment 1000 RPM or one segment for 500 RPM). In operation, the user first sets the speed segment and the corresponding color, as well as the rotational speed value (critical value) corresponding to the optimum time for shift switch, for example, at 500 RPM. 5000 RPM and above, the light source displays the same color. Then, during the car race when the rotational speed is between 0-1000 RPM, the light source generates light of one color, while the speed is between 1000-2000 RPM, the light source 2 switches to another color The color does not change until the speed reaches the critical speed value which is 5000 RPM and above, the light source displays the same color. Thus the user can easily recognize instant speed condition and perform the shift switching when the color of the light source changes.

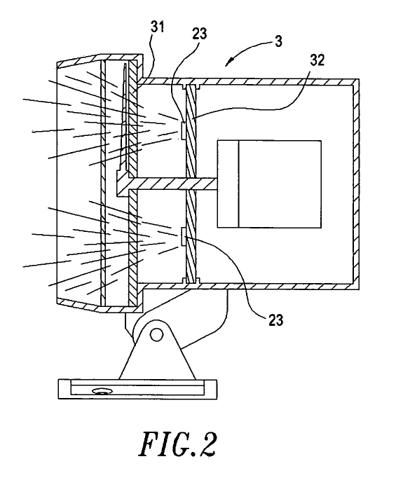

Referring to FIG. 2, which is the perspective cross sectional view of the tachometer device with the variable color projection source of this invention. In operating the tachometer 3, by setting the gear shift time for example, at 5000 RPM, a plurality of speed segments, each for 1000 RPM increment is set on the RGB illumination device set 23 installed on a circuit board 32 behind the graduation board 31 so as to change the color in order according to variation of the speed (for example: blue at 1000 RPM, green at 2000 RPM, yellow at 3000 RPM, purple at 4000 RPM). The light color turns to the constant color, red, after the engine rotating speed goes above the gear shifting speed 5000 RPM thereby reminding the driver of the present state of his/her car.

The tachometer device with the projection light source variable according to this invention has the following advantages in comparison with other traditional technologies:

1. The tachometer device with the projection light source variable according to the rotational speed utilizes the electric-control loop to drive the RGB illumination device set equipped in the tachometer body by means of which the device can switch the color of the light generated by the light source between red, green, blue, yellow, indigo-blue, purple, white under the control of the microprocessor program in correspondence to the rotational speed of the car engine. The color of the light can be changed to another color according to the rotational speed so that the user can easily recognize the instant speed condition during the high-speed driving.

2. The tachometer device with the projection light source variable according to the rotational speed has a RGB illumination device set provided in the tachometer body beneath the graduation board such that variable colored lights may be generated therefrom in order according to the preset speed segments thereby the driver can be remind of the present sate of his/her car by watching the color change displayed on the graduation board of the tachometer.

3. The tachometer of this invention provides for the user the opportunity to select colors in correspondence with each segment of the rotation speed according to the user's preference in order to let the user to feel comfortable in recognizing the instant speed as well as for performing gear shifting at the best time.

Many changes and modifications in the above-mentioned embodiment of this invention can, of course, be carried out without departing from the scope thereof. Accordingly, to promote the progress in science and the useful arts, the invention is disclosed and is intended to be limited only by the scope of the appended claims.

What is claimed is:

1. A tachometer device with a projection light source changing the color of a generated light according to a rotational speed of an engine. Said light source being provided in an electric circuit included in the meter body, said light source comprising:
a switch device outputting a switch signal or a present signal to an electronic control circuit;
said electronic control circuit receiving a control signal outputted from a microprocessor included in said electric circuit of said tachometer, or receiving said switch signal or said preset signal outputted form switch device, and being capable of collaborating all memory signals with a functional mode and outputting a driving signal to actuate an RGB illumination device set;
an RGB illumination device set appropriately disposed in the inner portion of said tachometer, namely beneath the graduation board of said tachometer for receiving said driving signal outputted from said electronic control circuit;
by outputting from said microprocessor the colors of said light source corresponding to the engine rotational speed which have been preset in a memory, and driving said RGB illumination device set with a synchronizing color mixing version by said electronic control circuit, the color of the projected light may be changed in order according to the preset speed segments thereby the driver is able to be reminded of the present state of his/her car by watching the color change displayed on said graduation board.

2. The tachometer device as claimed in claim 1, wherein said RGB illumination device set is installed on the circuit board behind said graduation board.

3. The tachometer device as claimed in claim 1, wherein said RGB illumination device generates the light of a plurality of colors, at least including red, green, blue, yellow, indigo-blue, purple, and white colors.
